(19) United States
(12) Patent Application Publication
(10) Pub. No.: US 2016/0188525 A1
(43) Pub. Date: Jun. 30, 2016

(54) APPARATUS WITH CONFIGURABLE SERIAL PORTS

(71) Applicant: GE Aviation Systems LLC, Grand Rapids, MI (US)

(72) Inventors: Melanie Sue-Hanson Graffy, Byron Center, MI (US); Morton Holman Harwood, Grand Rapids, MI (US); Eric Daniel Buehler, Grand Rapids, MI (US)

(21) Appl. No.: 14/585,238

(22) Filed: Dec. 30, 2014

(51) Int. Cl. G06F 13/42; G08G 5/00

(52) U.S. Cl. CPC G06F 13/4286; G08G 5/003; G06F 13/4282

(57) ABSTRACT

An apparatus for an aircraft receives and transmits data related to the aircraft. The apparatus includes at least one serial interface, a memory location, a plurality of interface protocols stored in the memory location and logic in communication with the memory location. The logic is configured to be encoded with at least one of the plurality of interface protocols according to data at the serial interface.

### BACKGROUND OF THE INVENTION

Contemporary aircraft typically include one or more avionics subsystems that serve a variety of functions related to operations of the aircraft. Exemplary avionics systems may include an Onboard Maintenance System (OMS) or a health monitoring or Integrated Vehicle Health Management (IVHM) system to assist in diagnosing or predicting faults in the aircraft, and a flight management system (FMS) to assist in flight plan management. Such systems are often embodied in apparatuses that receive and transmit data via serial interfaces. Contemporary aircraft often use a variety of protocols for the transmission of data. For example, RS-422 is a technical standard that specifies electrical characteristics of a digital signaling circuit; RS-485 is a technical standard that defines the electrical characteristics of drivers and receivers in balanced digital multipoint systems; and ARINC-717 is an industry standard that describes the form, fit, and function of avionics equipment in the acquisition of flight data for recording.

### BRIEF DESCRIPTION OF THE INVENTION

In one aspect, an embodiment of the invention relates to an apparatus for an aircraft that receives and transmits data related to the aircraft. The apparatus includes at least one serial interface, a memory location, a plurality of interface protocols stored in the memory location and logic in communication with the memory location and the at least one serial interface. The logic is configured to be encoded with at least one of the plurality of interface protocols according to data at the at least one serial interface.

### BRIEF DESCRIPTION OF THE DRAWINGS

In the drawings:

FIG. 1 is a perspective view of an aircraft in which embodiments of the invention may be implemented.

FIG. 2 is a diagram of an avionics system that transmits and receives serial data according to an embodiment of the invention.

### DESCRIPTION OF EMBODIMENTS OF THE INVENTION

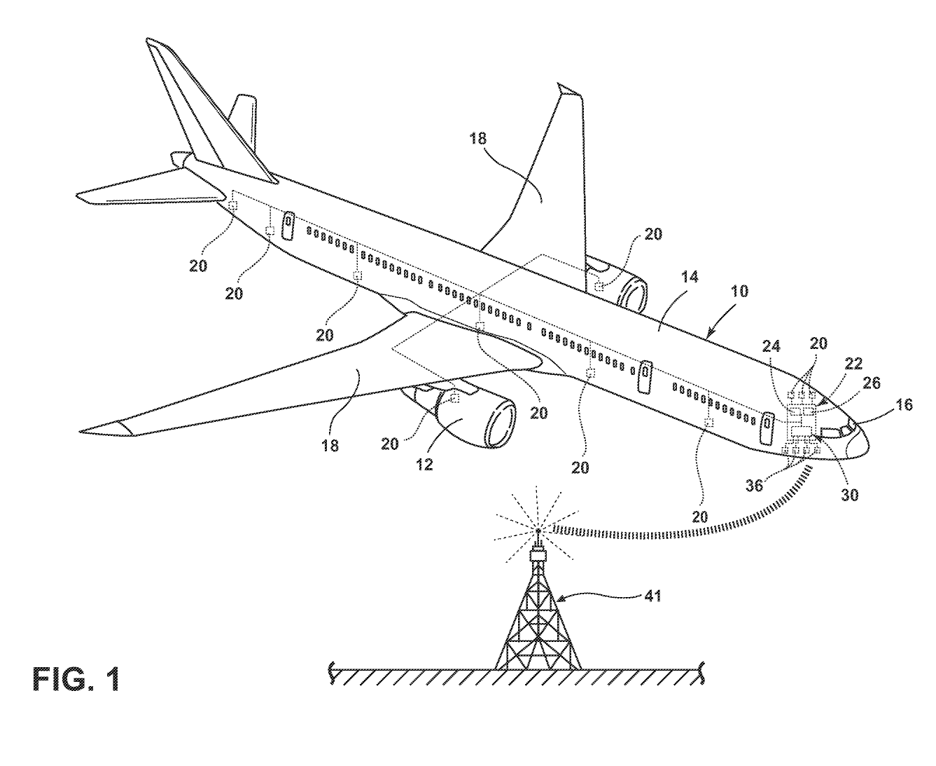

FIG. 1 schematically depicts an aircraft 10 that may execute embodiments of the invention and may include one or more propulsion engines 12 coupled to a fuselage 14, a cockpit 16 positioned in the fuselage 14, and wing assemblies 18 extending outward from the fuselage 14. While a commercial aircraft has been illustrated, it is contemplated that embodiments of the invention may be used in any type of aircraft, for example, without limitation, fixed-wing, rotating-wing, rocket, personal aircraft, and military aircraft.

A plurality of aircraft systems 20 that enable proper operation of the aircraft 10 may also be included in the aircraft 10 as well as one or more computers or controllers 22, which may be operably coupled to the plurality of aircraft systems 20 to control their operation. While only a single controller 22 has been illustrated, it is contemplated that any number of controllers 22 may be included in the aircraft 10. In such an instance, the controller 22 may also be connected with other controllers of the aircraft 10. The controller 22 may include or be associated with any suitable number of individual microprocessors, power supplies, storage devices, interface cards, auto flight systems, flight management computers, and other standard components. For example, the controller 22 may include memory 24, the memory 24 may include random access memory (RAM), read-only memory (ROM), flash memory, or one or more different types of portable electronic memory, such as discs, DVDs, CD-ROMs, etc., or any suitable combination of these types of memory. The controller 22 may also include one or more processors, which may be running any suitable programs. The controller 22 may include or cooperate with any number of software programs or instructions designed to carry out the various methods, process tasks, calculations, and control/display functions necessary for operation of the aircraft 10. The controller 22 is illustrated as being in communication with the plurality of aircraft systems 20 and it is contemplated that the controller 22 may aid in operating the aircraft systems 20 and may receive information from the aircraft systems 20. The controller 22 may be a portion of a flight management system (FMS), health management system (HMS), etc.

Further, a health management unit 30 has been illustrated as being included within the aircraft 10. The health management unit 30 may also be operably coupled to any number of the plurality of aircraft systems 20 and/or controllers to receive information therefrom. While illustrated as being included in the controller 22, the health management unit 30 may also be separate from the controller 22 or may be a part of any of the avionics systems such as an integrated modular avionics, onboard maintenance system, flight data recorder, etc. The health management unit 30 may collect or receive information, determine a critical failure or potential catastrophic event, assemble data that may not normally be collected, and transmit such data via access to one or more off-board interfaces.

The health management unit 30 may be implemented in any suitable software or hardware. For example, the health management unit 30 might include a general-purpose computing device in the form of a computer, including a processing unit, a system memory, and a system bus, that couples various system components including the system memory to the processing unit. The computer may be configured to determine a potential catastrophic event during the flight of the aircraft, assemble data indicative of a report of the aircraft state of operation upon the determining of a potential catastrophic event and controls transmission of the assembled data from the aircraft during the flight of the aircraft. The computer may also prepare a predefined report from the assembled data and transmit it. The computer may retrieve data from the aircraft and off-board data interfaces for the predefined report indicating the aircraft state of operation.

The health management unit 30 may include all or a portion of one or more computer programs having executable instruction sets for reporting critical failure information of the aircraft 10 and transmitting information from the aircraft 10. The program may include a computer program product that may include machine-readable media for carrying or having machine-executable instructions or data structures stored thereon. Such machine-readable media may be any available media, which can be accessed by a general purpose or special purpose computer or other machine with a processor. Generally, such a computer program may include routines, programs, objects, components, data structures, algorithms, etc., that have the technical effect of performing particular tasks or implementing particular abstract data types. Machine-executable instructions, associated data structures, and programs represent examples of program code for executing the exchange of information as disclosed herein. Machine-executable instructions may include, for example, instructions and data, which cause a general-purpose computer, special purpose computer, or special-purpose processing machine to perform a certain function or group of functions.

The controller 22 and/or the health management unit 30 may be communicably coupled to any number of communication links 36 to transfer data to and from the aircraft 10. Alternatively, the computer of the health management unit 30 may include a communication management module configured to determine what one of the multiple radios to use in transferring the data based on bandwidth, availability, or current utilization. It is contemplated that the communication links 36 may be wireless communication links and may be any variety of communication mechanism capable of wirelessly linking with other systems and devices and may include, but is not limited to, packet radio, satellite uplink, Wireless Fidelity (WiFi), WiMax, Bluetooth, ZigBee, 3G wireless signal, code division multiple access (CDMA) wireless signal, global system for mobile communication (GSM), 4G wireless signal, long term evolution (LTE) signal, Ethernet, or any combinations thereof. It will also be understood that the particular type or mode of wireless communication is not critical to embodiments of the invention, and later-developed wireless networks are certainly contemplated as within the scope of embodiments of the invention. Further, the communication links 36 may include one or more radios including voice, ACARS-analog, ACARS-digital, SATCOM, cellular, etc. The communication links 36 may allow for communication with ground controllers or airlines operations center at a ground-based station 41 or with non-ground stations such as satellite (not shown). Further, while only one ground-based station 41 has been illustrated, it will be understood that the aircraft may communicate with multiple ground-based stations 41 utilizing the communication links 36.

During operation, the health management unit 30 may utilize inputs from the plurality of aircraft systems 20. By way of non-limiting example, the health management unit 30 may be preconfigured to recognize key events that are considered potentially catastrophic. As the health management unit 30 monitors the aircraft 10 and its systems 20, upon detection of a catastrophic event, the health management unit 30 may begin to establish connections to any number of on-board systems 20 including by way of non-limiting examples a health management system and a navigation system and off-board data through communication links 36 and assemble data related to operational data, location data, and critical data related to the aircraft 10. For example, the health management unit 30 may assemble a preconfigured summary report of the aircraft state, position, and nature of the failure. The health management unit 30 may then transmit the assembled data or may control the transmission of the data over the communication links 36 for receipt by ground-based stations 41. The health management unit 30 may continue to broadcast the report or updated versions of the report for the duration of flight and/or until communication is no longer available. The health management unit 30 may be configured to recognize a potential catastrophic event as a single piece of information from a system 20 in the aircraft 10 or as a combination of events that need to be aggregated by the health management unit 30 to recognize that the aircraft 10 is in a potential catastrophic state.

It will be understood that details of environments that may implement embodiments of the invention are set forth in order to provide a thorough understanding of the technology described herein. It will be evident to one skilled in the art, however, that the exemplary embodiments may be practiced without these specific details. The exemplary embodiments are described with reference to the drawings. These drawings illustrate certain details of specific embodiments that implement a module or method, or computer program product described herein. However, the drawings should not be construed as imposing any limitations that may be present in the drawings. The method and computer program product may be provided on any machine-readable media for accomplishing their operations. The embodiments may be implemented using an existing computer processor, or by a special purpose computer processor incorporated for this or another purpose, or by a hardwired system.

As noted above, embodiments described herein may include a computer program product comprising machine-readable media for carrying or having machine-executable instructions or data structures stored thereon. Such machine-readable media may be any available media, which may be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium that can be used to carry or store desired program code in the form of machine-executable instructions or data structures and that can be accessed by a general purpose or special purpose computer or other machine with a processor. When information is transferred or provided over a network or another communication connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data, which cause a general-purpose computer, special purpose computer, or special purpose processing machines to perform a certain function or group of functions.

Embodiments may be implemented by a program product including machine-executable instructions, such as program codes, for example, in the form of program modules executed by machines in networked environments. Generally, program modules include routines, programs, objects, components, data structures, etc., that have the technical effect of performing particular tasks or implement particular abstract data types. Machine-executable instructions, associated data structures, and program modules represent examples of program codes for executing steps of the method disclosed herein. The particular sequence of such executable instructions or associated data structures represent examples of corresponding acts for implementing the functions described in such steps.

Embodiments may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the internet and may use a wide variety of different communication protocols. Those skilled in the art will appreciate that such network computing environments will typically encompass many types of computer system configurations, including personal computers, hand-held devices, multiprocessor systems, microprocessor-based or programmable consumer electronics, network PCs, minicomputers, mainframe computers, and the like.

Embodiments may also be practiced in distributed computing environments where tasks are performed by local and remote processing devices that are linked (either by hardwired links, wireless links, or by a combination of hardwired or wireless links) through a communication network. In a distributed computing environment, program modules may be located in both local and remote memory storage devices.

The plurality of aircraft systems 20 that provide input data to the health management unit 30 may communicate via one of a plurality of serial data protocols. That is, each aircraft system 20 may sequentially transmit data along a communication channel or bus one bit at a time. The format that defines the serial communication including the syntax, semantics and synchronization of messages transmitted along the serial communication channel form the communications protocol. Example serial data protocols include, but are not limited to, RS-422 transmit, RS-422 receive, RS-485, ARINC-717 receive, ARINC-717 transmit, etc. An aircraft 10 may include aircraft systems 20 or communications links 36 that communicate by more than one serial data protocols. Consequently, the health management unit 30 may need to input or output data via a serial input/output (I/O) device 26 transmitted in multiple serial data protocols. Additionally, health management units installed in different aircraft may require compatibility with different serial data protocols. To accommodate all protocols used in an aircraft, an apparatus for avionics subsystems may include a custom interface for each protocol. Each custom interface may require a separate and independent circuit, which adds cost in aircraft design and in weight

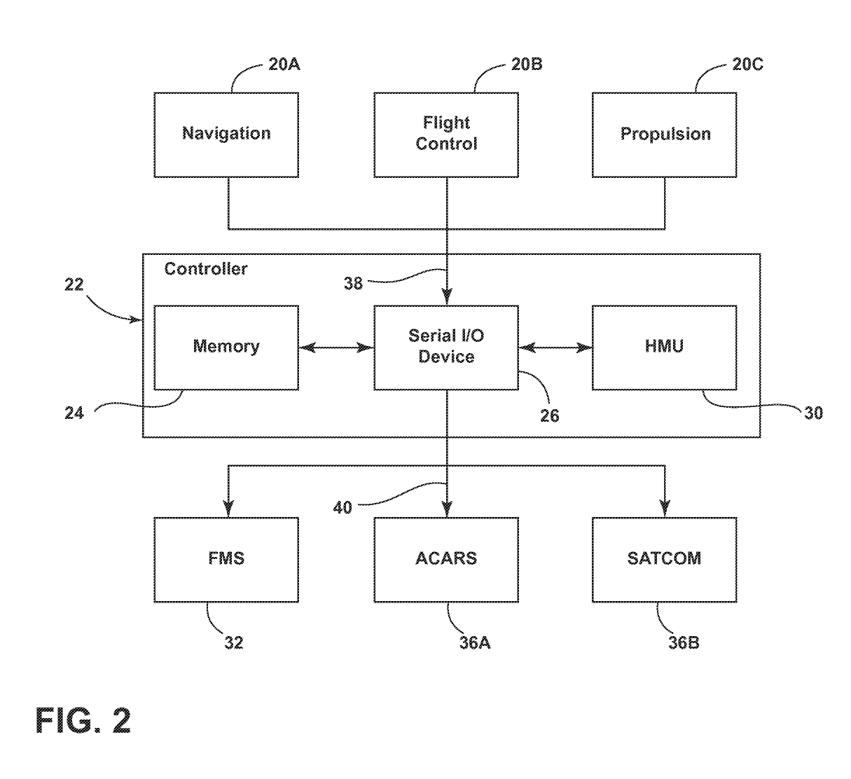

According to an embodiment, FIG. 2 is a diagram of an avionics subsystem that includes an apparatus that transmits and receives serial data where the supported serial interface protocols are configurable. The apparatus may be configured to transmit, receive or transmit and receive data depending upon the implementation. The apparatus for transmitting and receiving serial data includes a serial I/O device 26 connected to a location in memory 24. The apparatus includes at least one serial interface 38. The location in memory 24 includes a plurality of serial interface protocols any of which are encodable as either an input, an output or both.

As shown, the serial interface 38 may be configured to be input-only for serial data but may include one or more additional serial interfaces 40 such as an output-only connection. The serial interface 38 may be bi-directional, that is, configured for both serial input and output data, but alternatively may be one directional, that is, configured only for serial input or only for serial output. Logic in communication with the location in memory 24 may be configured to encode data received at a serial interface 38 according to an input interface protocol. Similarly, logic in communication with the location in memory 24 may be configured to encode data transmitted at serial interface 40 according to an output protocol.

The encoded logic in the serial I/O device 26 may translate data from an encoded input interface protocol to an encoded output interface protocol. The encoded output protocol may differ from the encoded input protocol. Alternatively, the encoded output protocol may be the same as the encoded input protocol whereby the serial I/O device 26 acts as a pass-through for the serial data message. The serial I/O device 26 may act as multiple serial interfaces and may include multiple inputs or multiple outputs, each independently configured to encode a separate serial protocol. The serial I/O device 26 is preferably a field-programmable gate array (FPGA), though other configurable hardware solutions may include a configurable processor.

To convert data from an input protocol to an output protocol, the encoded logic may include translating the data according to electrical characteristic values as dictated by the respective protocols. For example, though similar, RS-485 and RS-422 specifications include electrical differences related to their common-mode voltage ranges and receiver-input resistances. The logic encoded in the serial I/O device 26 may compensate for these electrical differences when translating data streams from an input to an output channel. In addition, the encoded logic for the protocols may include translating between other aspects that form the differences between the input and output protocols. For example, the serial I/O device 26 may need to introduce a governor or buffer to compensate between different data rates inherent to the different protocols. Error checking procedures, data redundancy checks and handshaking negotiations may need to be added or removed from a data stream depending on the requirements of the differing serial data input and output protocols encoded in the serial I/O device 26.

During installation of the serial I/O device 26, a truth table may be configured in the memory location that enables the encoding of an input for a serial interface 38 and an output protocol for a serial interface 40. In this way, the encoded input protocol and the encoded output protocol may be predetermined in the memory location. Alternatively, the serial I/O device 26 may include an additional capability to automatically determine the input serial protocol based on the incoming data.

In one application, the apparatus includes a hardware circuit that includes a two-pin connector to an external communications channel. A processor executing a software program is in communication with the hardware circuit and selects an interface protocol for the communications channel. For example, the interface protocol may be selected as one of the following list:

RS-422 receive with termination enabled

RS-422 receive with termination disabled

RS-422 transmit with termination disabled

ARINC 717 Harvard Bi-Phase receive

ARINC 717 Harvard Bi-Phase transmit.

In this application, the term ‘termination’ refers to 100-ohm resistance between the two pins on the box connector, ‘receive’ refers to an input signal from external cabling to the two pins connector and ‘transmit’ refers to an output signal sent from the apparatus to external cabling on the two pin connector. “Harvard Bi-Phase” is one of the options described in ARINC 717.

In another application, the serial I/O device 26 may be configured as a part of a health management system whereby data from various aircraft systems are directed to a controller 22 and interfaced by the serial I/O device 26 and at least one input 38. For example, data may come from avionics systems including a navigation system 20A, a flight control system 20B or a propulsion system 20C. The data may be translated to a protocol readable by the health management unit 30. Data output from the controller 22 of the health management system may be translated to one or more output protocols by the serial I/O device 26 and transmitted out at least one output interface 40. For example, the output of the serial I/O device 26 may be coupled to one or more communication links such as an ACARS system 36A or a SATCOM system 36B to transfer data from the aircraft.

Though presented in the context of an aircraft health management system, the serial I/O device 26 may be implemented in any aircraft system or subsystem where serial data is necessarily transmitted between subsystems, particularly where the data transmitting or receiving subsystems may employ various serial data protocols. In this way, the serial I/O device 26 may be equally applicable to a flight management system 32 or flight data recording system (not shown). Additionally, though the location in memory 24 may be a separate component from the serial I/O device 26, it may be integrated directly with the serial I/O device 26.

Technical effects of the above-described embodiments include the configurable serial interface allowing one unit level interface to communicate over a variety of protocols without requiring additional hardware pins and additional unit weight that is inherent to traditional physical interfaces. Additionally, the avionics subsystem allows any number of interfaces to be supported all while keeping the number of physical interconnects, and consequently, the weight to a minimum. The configurability of the embodiments provides flexibility for a customer's interface for their aircraft's systems while keeping the assembly small and lightweight.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An apparatus for an aircraft that receives and transmits data related to the aircraft comprising:
at least one serial interface;
a memory location;
a plurality of interface protocols in the memory location; and
logic in communication with the memory location and the at least one serial interface, and configured to be encoded with at least one of the plurality of interface protocols according to data at the at least one serial interface.

2. The apparatus of claim 1 wherein the at least one serial interface includes at least one serial input and the plurality of interface protocols includes at least one input protocol.

3. The apparatus of claim 1 wherein the at least one serial interface includes at least one serial output and the plurality of interface protocols includes at least one output protocol.

4. The apparatus of claim 1 wherein the at least one serial interface includes at least one serial input and at least one serial output.

5. The apparatus of claim 4 wherein the plurality of interface protocols in the memory location includes a plurality of input protocols and a plurality of output protocols.

6. The apparatus of claim 5 wherein the logic transmits data according to a selected output protocol.

7. The apparatus of claim 5 wherein the logic translates data from a selected input protocol to a selected output protocol where the selected output protocol differs from the selected input protocol.

8. The apparatus of claim 5 wherein a selected input protocol is the same as a selected output protocol.

9. The apparatus of claim 1 wherein an interface protocol is automatically selected based on the data at the at least one serial interface.

10. The apparatus of claim 1 wherein a selected interface protocol is predetermined in the memory location.

11. The apparatus of claim 1 wherein the apparatus is an avionics subsystem that is one of a health management system, a flight management system or a flight data recording system.

12. The apparatus of claim 1 wherein the logic comprises a field-programmable gate array (FPGA).

13. The apparatus of claim 1 wherein the plurality of interface protocols include RS-422 receive, RS-485 and ARINC-717 receive.

14. The apparatus of claim 1 wherein the plurality of interface protocols include RS-422 transmit, RS-485 and ARINC-717 transmit.
